(19) United States
(12) Patent Application Publication
(10) Pub. No.: US 2017/0011101 A1
(43) Pub. Date: Jan. 12, 2017

(54) EFFICIENT PROCESSING OF DEVICE RELATED LOG FILES

(71) Applicant: Koninklijke Philips N.V., Eindhoven (NL)

(72) Inventors: Shankar Mosur VENKATESAN, Bangalore (IN); Biswaroop CHAKRABARTI, Kolkata (IN); Karthik SUBBARAMAN, Mumbai (IN); Nagaraju BUSSA, Hyderabad (IN); Anand Srinivasan SRINIVASAN, Chennai (IN); Deep BERA, Bangalore (IN)

(21) Appl. No.: 15/116,257

(22) PCT Filed: Feb. 9, 2015
(86) PCT No.: PCT/IB2015/050944

§ 371 Date: Aug. 3, 2016

Related U.S. Application Data
(60) Provisional application No. 61/941,097, filed on Feb. 18, 2014.

(51) Int. Cl. G06F 17/30; G06F 19/00

(52) U.S. Cl. CPC G06F 17/30554; G06F 17/30327; G06F 17/30911; G06F 19/3406; G06F 3/0482

(57) ABSTRACT

A method includes searching a single file, which includes a plurality of device log files for one or more devices, based on a template file that at least indicates a sub-set of log data of interest, generating reference data for each of the log data of interest that is located in the single file, and storing the reference data in a data structure. A computing system (102) includes a memory (114) that stores one or more instructions (120) including a log file processing module (126), and a processor (116) that executes the one or more instructions, which causes the processor to: filter log data based on a template file that indicates streams of data of interest; dynamically change the amount of data of interest based on the debug level; store the streams of data of interest; and display, in response to an input signal, a sub-set of the stored virtual stream of data of interest.

The following generally relates to efficient processing of device related (e.g., device, service, etc.) log files for devices including, but not limited to, a medical and/or a non-medical imager (e.g., computed tomography (CT), X-ray, Ultrasound (US), magnetic resonance (MR), positron emission tomography (PET), single photon emission computer tomography (SPECT), etc.) and/or non-imaging equipment.

Some electro-mechanical software devices are configured to generate log files that include system and/or operational parameters. The log files from multiple devices located at a facility typically are stored as flat files. A flat file, generally, is a single file with a serial stream of all the system and/or operational parameters of the devices. Flat files from multiple facilities within a network of facilities are often periodically sent to and archived in a server and/or database.

When a particular one of the devices has an event that requires service, the flat file with the device log files of the device are retrieved from the archive and manually evaluated by a field service engineer. Unfortunately, a flat file of device log files can include megabytes, gigabytes, terabytes, etc. of data, and the field service engineer may have to read through a large volume of this data to locate only kilobytes of data that provide any clue as to why the event might have occurred.

An immediate and direct consequence is that an end user or customer may face device downtime and losses that could have been avoided if the pertinent device log files were promptly extracted based on enhanced debug logging mechanism based on types of error events from the flat file, evaluated, and used to predict or prevent reoccurrence of the event. Such information can also be used in connection with the design of future devices, for example, based on the analysis of the event from a technical and/or a reliability point of view.

Field service engineers, who visit and repair or service the particular device, generate electronically formatted reports or service log files that memorialize the visit. Such reports may include troubleshooting steps, diagnostics performed to determine and/or fix the problem, results of the service visit, etc. Similar to device log files, the service log files typically are just archived, and no attempt is made to derive information from the log files.

Healthcare medical devices represent a large financial investment for a customer. As such, the devices require a diagnostic and prevention system to mitigate downtime. However, given the volume, variety and/or velocity of the above discussed two orthogonal streams of connected data (i.e., device logs and service logs), it may be difficult to manually evaluate the log files.

Automated or semi-automated approaches, e.g., based on machine learning and data mining, can be employed to evaluate the log files. However, such approaches lack features, and otherwise well-designed devices that could potentially be serviced in days are serviced in weeks or longer, resulting in loss of customer revenue, satisfaction, and brand loyalty.

Aspects described herein address the above-referenced problems and others.

The following describes an approach to capture and organize device and/or service logs, using layered, efficient, and virtual streams defined by a template and debug levels, which can be machine learned over time to build a knowledge based system over time. The following further describes an approach to present the log data in visual concept maps, which can provide productive and fast navigation along time, topic, item, and concept axes.

In one aspect, a method includes searching a single file, which includes a plurality of device log files for one or more devices, based on a template file that at least indicates a sub-set of log data of interest. The method further includes generating reference data for each of the log data of interest that is located in the single file. The method further includes storing the reference data in a data structure.

In another aspect, a computing system includes a memory that stores one or more instructions including a log file processing module. The computing system further includes a processor that executes the one or more instructions, which causes the processor to: filter log data based on a template file that indicates streams of data of interest; dynamically change the amount of data of interest based on the debug level, store the streams of data of interest; and display, in response to an input signal, a sub-set of the stored virtual stream of data of interest.

In another aspect, a computer readable storage medium is encoded with one or more computer executable instructions. The one or more computer executable instructions, when executed by a processor of a computing system, causes the processor to: retrieve, using references, a sub-set of log data from a flat file of log data, in response to a user input, which includes at least an indication of data of interest to the user, and display only the retrieved sub-set of log data in a predetermined organized manner in a user-interactive navigational graphical user interface.

The invention may take form in various components and arrangements of components, and in various steps and arrangements of steps. The drawings are only for purposes of illustrating the preferred embodiments and are not to be construed as limiting the invention.

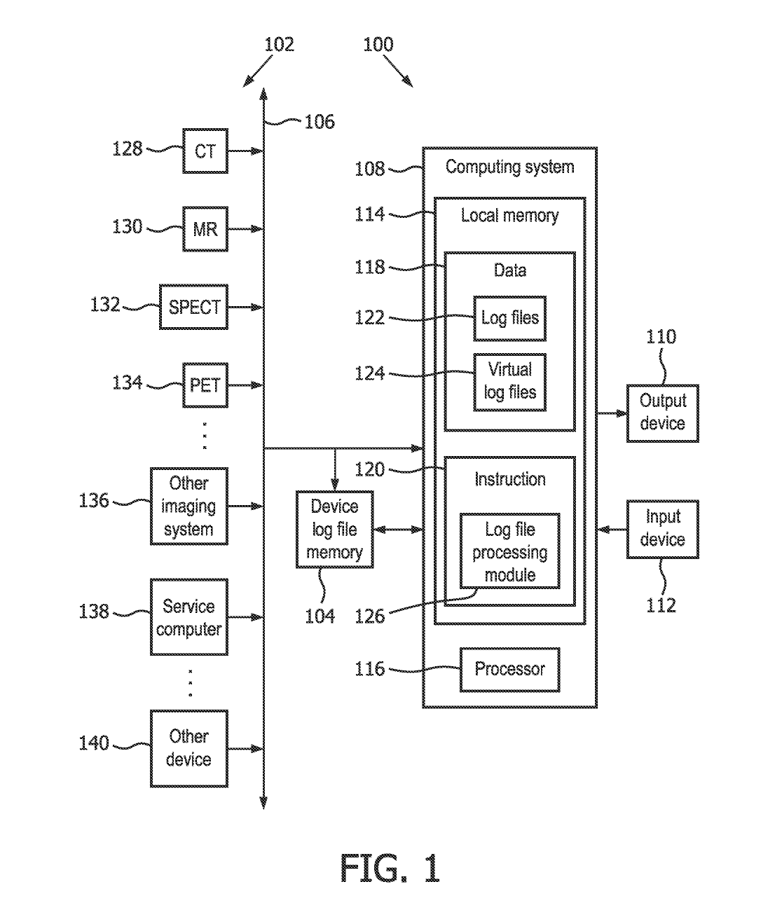

FIG. 1 schematically illustrates an example log server, which includes a log file processing module, in connection with a plurality of devices and a device log file memory.

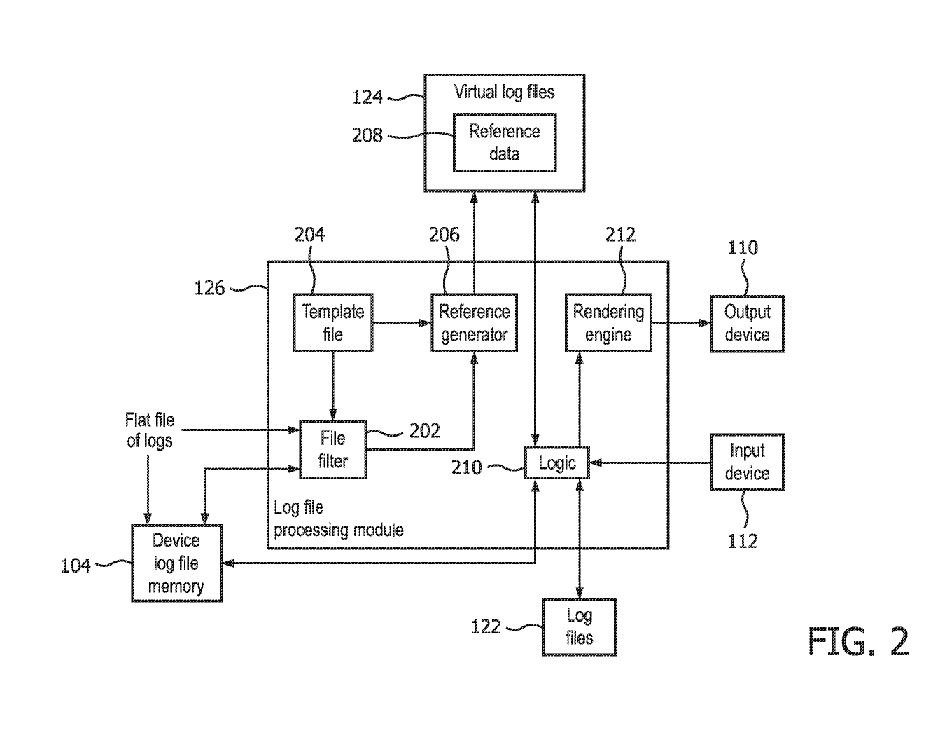

FIG. 2 schematically illustrates an example of the log file processing module of the log server of FIG. 1.

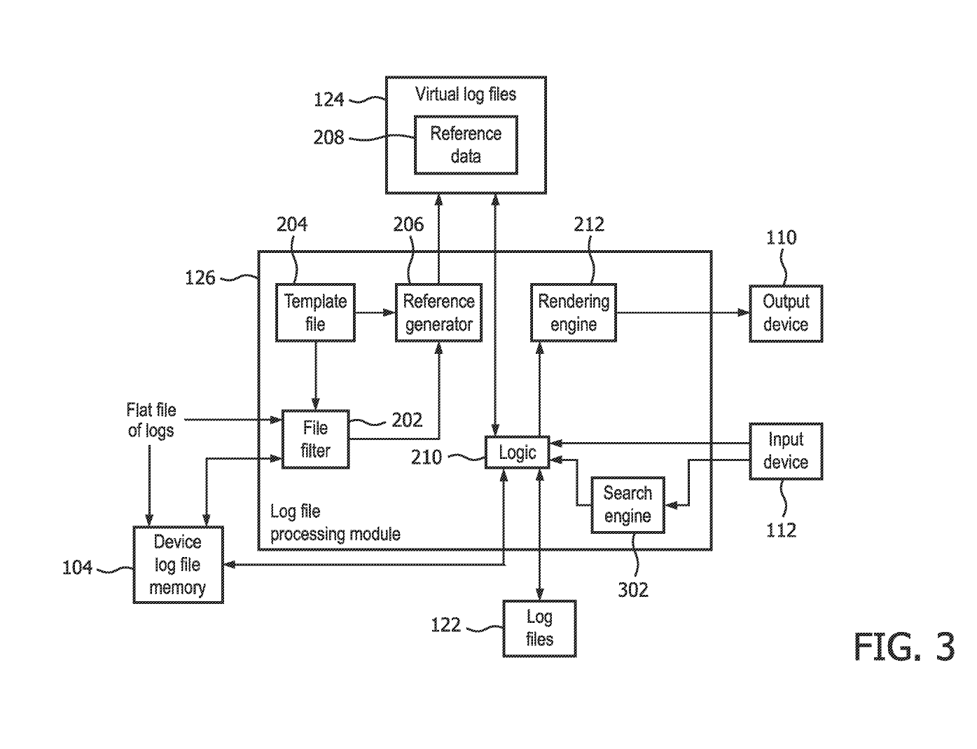

FIG. 3 schematically illustrates a variation of the log file processing module of FIG. 2, which includes a search engine.

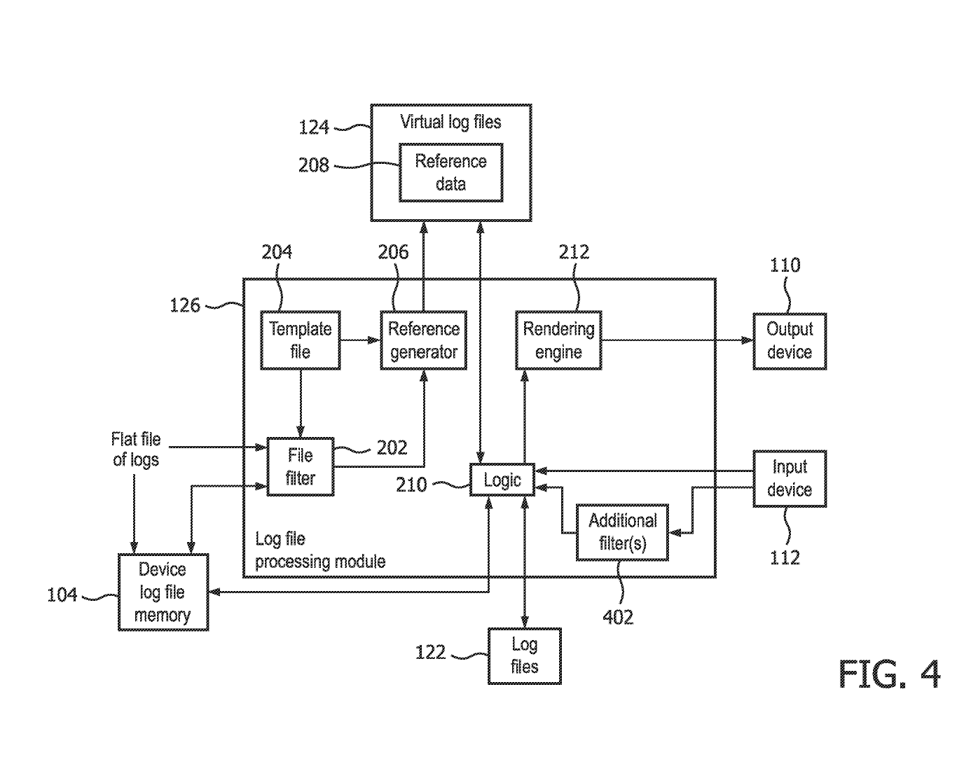

FIG. 4 schematically illustrates a variation of the log file processing module of FIG. 2, which includes one or more additional filters.

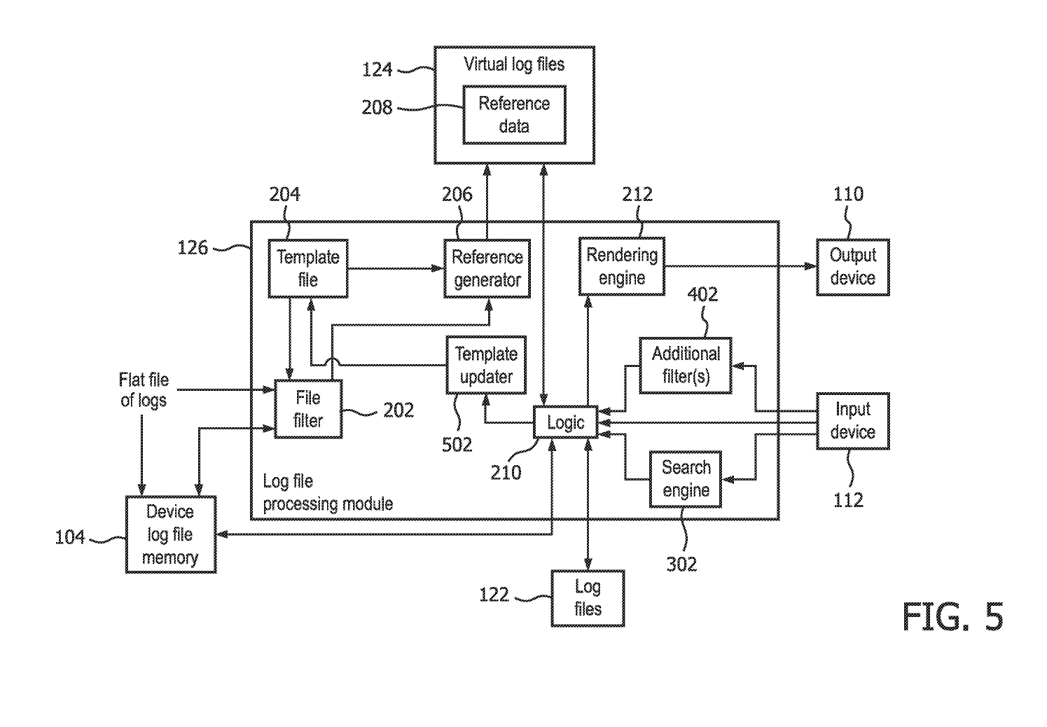

FIG. 5 schematically illustrates a variation of the log file processing module of FIG. 2, which includes the search engine of FIG. 3, the one or more additional filters of FIG. 4, and a template file updater.

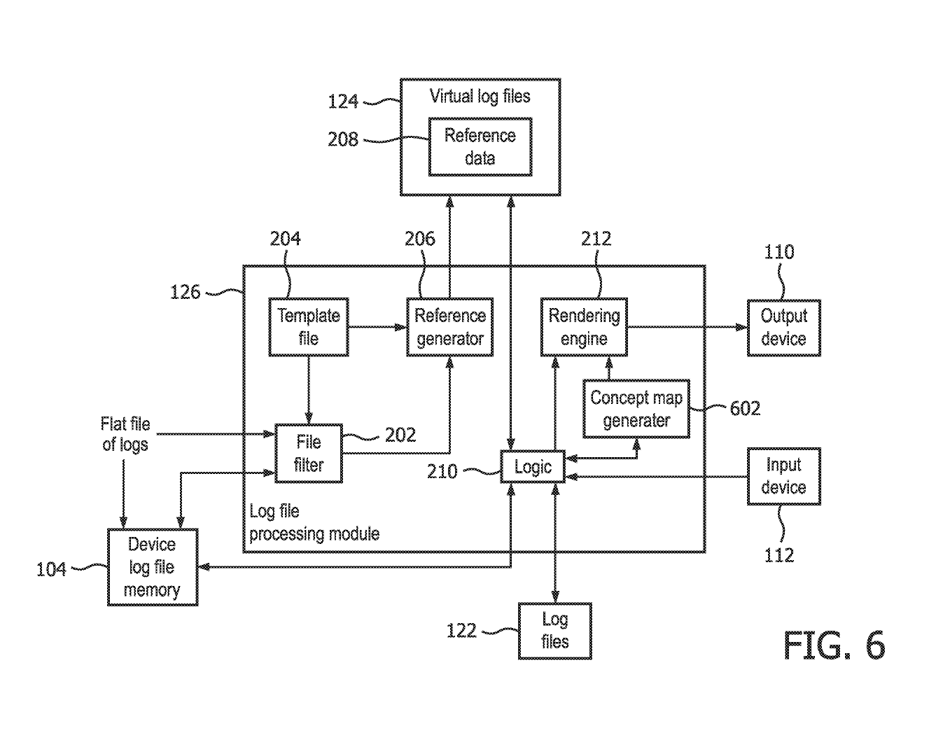

FIG. 6 schematically illustrates a variation of the log file processing module of FIG. 2, which includes a concept map generator.

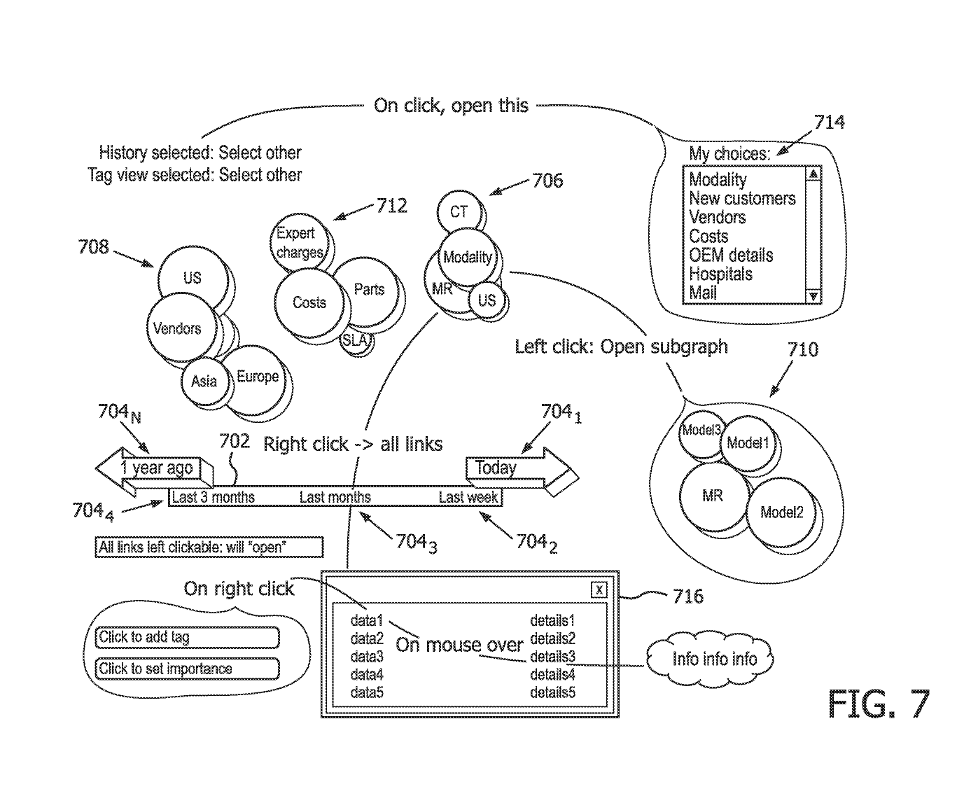

FIG. 7 schematically illustrates an example time based concept map generated by the concept map generator of FIG. 6.

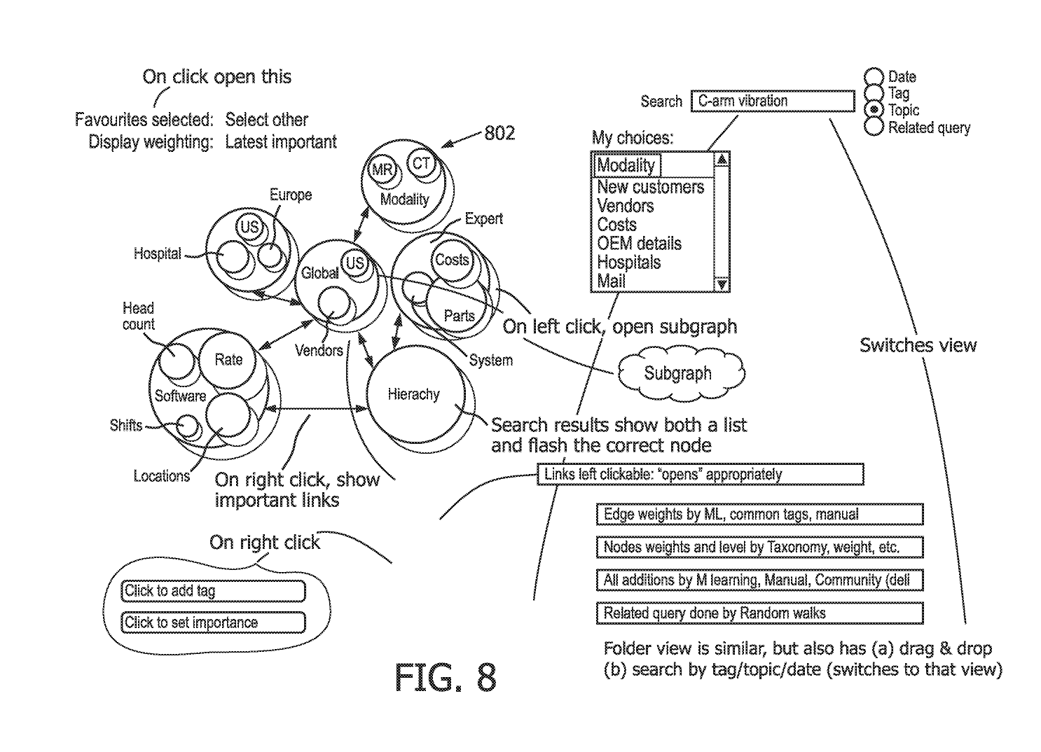

FIG. 8 schematically illustrates an example topic based concept map generated by the concept map generator of FIG. 6.

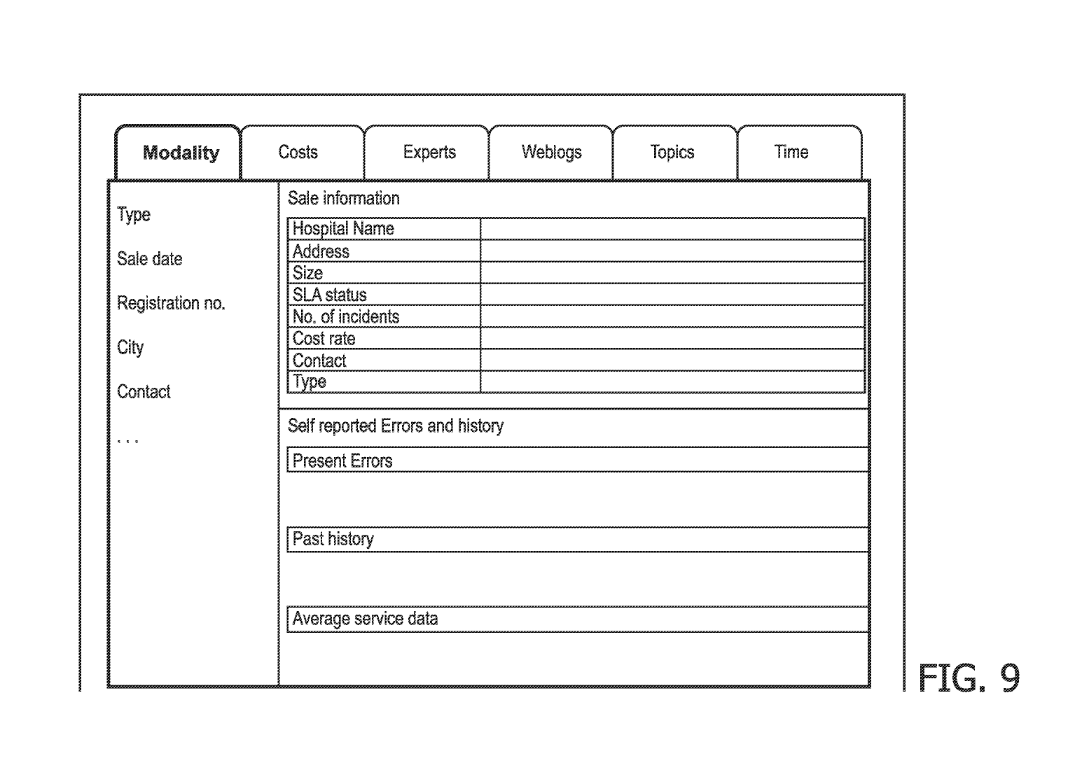

FIG. 9 schematically illustrates an example modality based concept map generated by the concept map generator of FIG. 6.

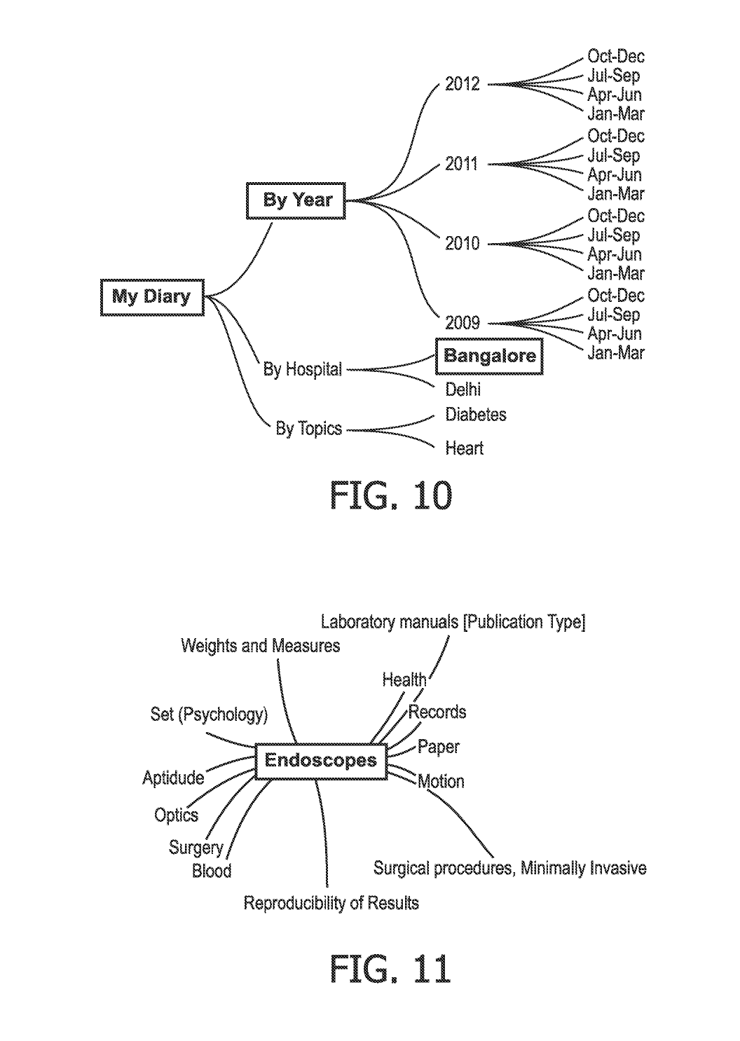

FIG. 10 schematically illustrates an alternative display using textual indicia instead of a concept map.

FIG. 11 schematically illustrates another alternative display using textual indicia instead of a concept map.

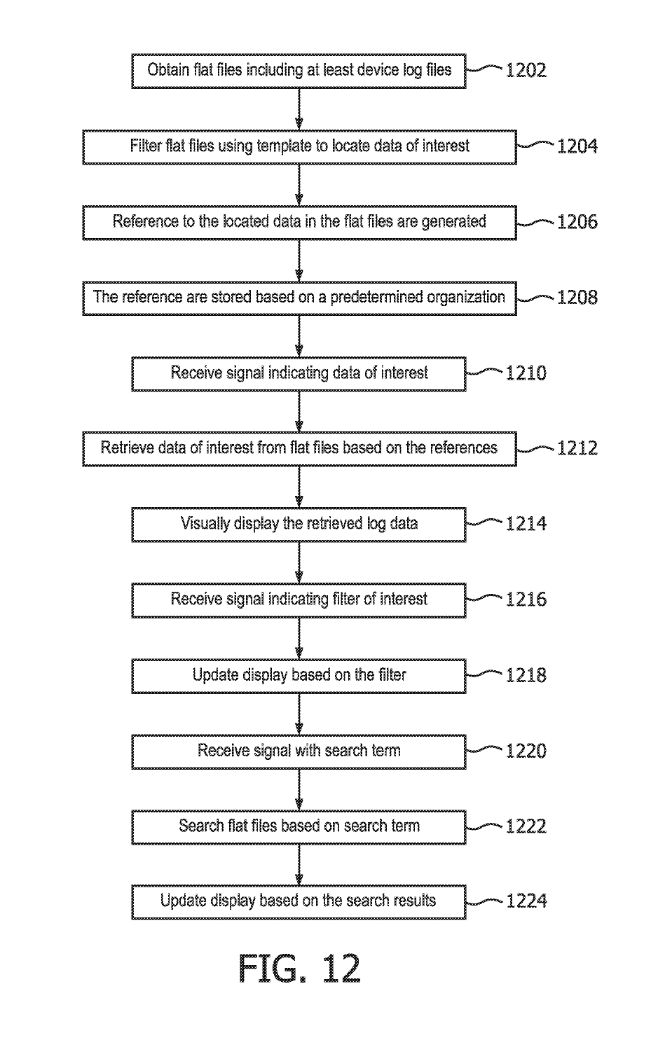

FIG. 12 illustrates an example method in accordance with the embodiments disclosed herein.

Initially referring to FIG. 1, a log server 100 is schematically illustrated in connection with a plurality of devices 102 and a device log file memory 104. The illustrated devices include a CT imaging system 128, an MR imaging system 130, a SPECT imaging system 132, a PET imaging system 134, ..., other imaging system 136, a service computer 138, and/or other device 140. Examples of the CT, MR, SPECT, and PET imaging systems 128-134 are described below.

The log server 100 processes, at least, log files generated by one or more of the plurality of devices 102. The log files can be obtained, for example, over a (wireless and/or wired) network 106 (e.g., the Internet, a wide area network, a local area network, etc.), by the log server 100, for example, directly from the plurality of devices 102 and/or from the device log file memory 104, which stores at least a sub-portion of the log files. The log files can also be obtained through portable storage medium.

A device of the plurality of devices 102 can transmit one or more log files over the network 106 as a single file such as a single flat file. Such a file may include multiple log files that are serially streamed with no structural relationship between the data and/or the log files therein. Suitable formats include comma-separated, delimiter-separated, and/or other flat files. Other formats, including structured formats are also contemplated herein.

By way of non-limiting example, a flat file generated by one of the devices 102 can include information about the scans performed since the last flat file transmission and/or system state information, even when no scan is performed. For example, for the CT imaging system 128, the log file may include patient identifiers, imaging protocol identifiers, scan time lengths, kV settings, mA settings, system temperatures, a list of calibration routines performed, etc.

A flat file from one facility may look something like the following: /facility:HospitalX/state:OH/Name:JohnDoe/device:CT/protocol:Chest/kV:100/ . . . , /facility:ClinicY/state:NY/Name:JaneDoe/device:US/protocol: abdomen/MHz:5/ . . . , /facility:OfficeZ/state:FL/temp:21° C./ . . . . The foregoing is just an example, and not limiting. Generally, a flat file consists of value pairs which can be parsed using a pre-defined grammar based parser and stored in a file format such as XML and/or file format. A service report log file from the service computer 138 may include textual information such as troubleshooting steps, diagnostics performed, results obtained, etc.

The single flat file can by pushed by the one of the plurality of devices 102 and/or pulled by the log server 100, for example, based on a predetermined schedule, on demand, etc. The plurality of devices 102 can include two or more of a same type of device. (i.e., two or more CT imagers, for example). One or more of the plurality of devices 102 can be at a same or different physical location (e.g., within a same physical facility or entity), a same or different geographical location (e.g., same or different state, country, etc.), etc.

The log server 100 includes a computing system 108, an output device 110 and an input device 112. The output device 110 includes a human readable output device such as a physical hardware based display monitor and/or the like. The input device 112 includes one or more of a keyboard, mouse, touchscreen region of the display monitor, and/or the like. The computing system 108 includes a computer readable storage medium (“local memory”) 114 and a processor 116.

The local memory 114 includes physical memory and/or other non-transitory storage medium and excludes transitory medium. The local memory 114 stores data 118 and at least one computer executable instructions (“instruction”) 120. The data 118 includes at least log files 122, which can be the same log files stored in the device log file memory 104 and/or other log files, and virtual log files 124. As described in greater detail below, the virtual log files 124 include only references to a sub-set of the log files stored in the device log file memory 104 and/or the log files 120 stored in the local memory 114.

The instruction 120 includes at least a log file processing module 126. As described in greater detail below, the log file processing module 126 processes contents of log files in single files based on predetermined criteria, creates organized references for a sub-set of data in the log files, retrieves at least a sub-portion of the sub-set from the device log file memory 104, extracts most relevant parameters from the log files using processor 116 and/or the log files 122 based on an input signal from the input device 112 using the references, and displays the retrieved sub-portion of the data, which may include displaying retrieved data via one or more content maps visually displayed in a graphical user interface (GUI). The processor 116 decides the amount of the logs to be stored in device memory 104 based on the debug level changes made based on the error events in devices 102.

In one instance, the organization of the data and display of the sub-portion of the data can provide for quick and/or intuitive visual navigation of large volumes of complex device and/or service log files and subsequent resolution of device issues. As a result, log files can be efficiently processed and used to troubleshoot and fix devices, identify warning signs and/or rare events, predict device degradation and/or failure, design future devices, etc. As such, device downtime can be mitigated, service time can be reduced, etc., which can reduce the cost of a device associated with device downtime and repair, and increase device uptime and billable time.

The processor 116 is, for example, a microprocessor, a central processing unit, a controller, or the like. The processor 116 implements the at least one instruction 120, including the log filed processing module 126.

The log server 100 can also communicate with other log servers and/or computing systems.

An example CT imaging system 128 includes a stationary gantry and a rotating gantry, which is rotatably supported by the stationary gantry and rotates around an examination region about a z-axis. A radiation source, such as an x-ray tube, is rotatably supported by the rotating gantry, rotates with the rotating gantry, and emits radiation that traverses the examination region. A radiation sensitive detector array subtends an angular arc opposite the radiation source across the examination region. The detector array detects radiation traversing the examination region and generates projection data indicative thereof A reconstructor reconstructs the projection data, generating 3D volumetric image data.

An example MR imaging system 130 includes a main magnet, gradient (x, y, and z) coils, and a RF coil. The main magnet (superconducting, resistive, or permanent) produces a substantially homogeneous, temporally constant main magnetic field B₀ in the examination region. The gradient coils generate time varying gradient magnetic fields along the x, y, and z-axes of the examination region. The RF coil produces radio frequency signals (at the Larmor frequency of nuclei of interest (e.g., hydrogen, etc.)) that excite the nuclei of interest in the examination region and receive MR signals emitted by the excited nuclei. A MR data acquisition system processes the MR signals, and a MR reconstructor reconstructs the data and generates MR images.

An example SPECT imaging system 132 includes a gamma radiation detector and a collimator, which is disposed between an examination region and the gamma radiation detector. The collimator includes radiation attenuating septa that only allow gamma radiation having a certain angle of incidence to reach the gamma detector. Gamma rays are acquired from a number of angles with respect to the examination region by rotating the gamma radiation detector around the examination region. The detector generally is positioned close to the subject under evaluation. A SPECT reconstructor reconstructs the projections to produce volumetric data representative of the distribution of the radioisotope emitting the gamma rays in the object or subject.

An example PET imaging system 134 includes a ring of gamma radiation detectors arranged around an examination region. The detectors are configured to detect 511 keV gamma rays indicative of electron-positron decays occurring in an examination region. Most decays result in two 511 keV gamma rays emitted almost 180 degrees to each other, and PET scanners localize the source along a line of response (LOR) there between. The detectors convert the photons into a corresponding electrical signal, and a coincidence event identifier identifies coincident gamma pairs by identifying photons detected in temporal coincidence. The identified pairs are used to generate data indicative of the spatial distribution of the decays.

The other imaging system 136 may include an x-ray imaging system, an ultrasound imaging system, etc. The service computer 138 may include a laptop, a desktop, a tablet, etc. computer, a smartphone, and/or other computing device. The other device 140 may include another medical device and/or a non-medical device.

FIG. 2 illustrates an example of the log file processing module 126.

The illustrated log file processing module 126 includes a file filter 202. The file filter 202, in the illustrated embodiment, filters flat files of file logs. As discussed herein, such files can be obtained in streams from the plurality of devices 102, the device log file memory 104.

The illustrated log file processing module 126 further includes a template file 204 that indicates the log files and/or log data that references will be created for. For example, the template file 204 may indicate (e.g., via a symbolic tag or regular expression and/or otherwise) that a reference is to be created to a log file for a particular type of device (e.g., “CT”), a particular geographical location (e.g., “OH”), etc. The template file 204 may also indicate other information such a debug level for the data.

The template file 204 can be formatted in a human and computer readable format such as a markup language (e.g., Extensible Markup Language (XML), etc.), a B-tree, and/or other format. An initial template file can be created through user interaction in which a user indicates the log data of interest. The template file 204 can be updated through similar user interaction and/or machine learning approaches.

With continuation to the example flat file discussed above, the template file 204 may indicate that a reference is to be created for all instances of log files with the string “OH.” As such, the file filter 202 reads the flat file and locates the string “OH.” With this example, the file filter 202 locates the log files /facility:OfficeZ/state:OH/temp:21° C./ . . . and /facility:HospitalX/state:OH/Name:JohnDoe/device:CT/protocol:Chest/kV:100/ . . . . Again, this example is provided for explanatory purposes and is not limiting.

The file filter 202, in response to finding a log file in the flat file as indicated by the template file 204, generates a signal. The illustrated log file processing module 126 further includes a reference generator 206 that, in response to receiving the signal, generates a reference for the log file. As utilized herein, the reference includes an address to a memory location that stores an address to the corresponding log file in the stored flat file. An example of such a reference is a pointer.

Where the template file 204 also indicates debug levels, the reference generator 206, alternatively, generates a first reference for one or more data elements in the log file and a second reference, or an address to a memory location that stores a debug level value. By way of example, the template file 204 may indicate that data “kV” is level “5,” “high,” etc. and that data “protocol” is level “3,” “medium,” etc., and not assign a level to data “Name” or assign a level “0,” “low,” etc.

In the instance where no debug level is provided, the reference generator 206 stores the reference to a log data in reference data 208 of the virtual log files 124. In the instance where a debug level is provided, the reference generator 206 stores the references to the log data and to the debug level in the reference data 208 of the virtual log files 124. The reference data 208, in one non-limiting instance, is stored in a data structure, which provides a predetermined organization of the references.

The illustrated log file processing module 126 further includes logic 210. The logic, in response to receiving an input signal, which indicates a particular data facility (e.g., “HospitalX”) along with a particular debug level (e.g., “medium to high”) from the input device 112, retrieves all the references from the reference data 208 that corresponds to the data with the debug level “medium to high” from the log file for “HospitalX”. In our example above, the logic 210 would retrieve the portion of the log file that includes the string “100” or the value 100 and the string “Chest.”

If there is an increase or decrease in debug level, the logic 210 will correspondingly increase or decrease the amount of the device log file memory 104 for storing log file information.

The logic 210, in response to receiving a subsequent input signal (indicative of data of interest to the user) from the input device 112, which indicates other data and/or debug level, retrieves data and updates the results accordingly. The illustrated log file processing module 126 further includes a rendering engine 212 that formats the retrieved data in a human readable format and displays the formatted data through the output device 112.

For clarity and sake of brevity the foregoing was described in connection with a limited number of log files, log file data of interest, and debug levels, and it is to be understood that the foregoing examples are not limiting.

FIG. 3 illustrates a variation of FIG. 2 in which the log file processing module 126 further includes a search engine 302. The search engine 302 allows the user to search the stored log files and/or stored references. This can be achieved by providing, via the input device 112, search terms to the search engine 302, and invoking, via the input device 112, the search engine 302 to perform a search based on the search terms through the logic 210. The search terms, in one instance, may correspond to data that is relevant to the user for the particular task. A separate index can be created and persisted for each static stream, and dynamic streams can be created as needed for each debug session. The presented search results can be ranked or unranked.

FIG. 4 illustrates a variation of FIG. 2 in which the log file processing module 126 further includes a one or more additional filters 402. For example, a particular filter may inhibit or remove certain data from display and/or from data retrieval. Such data may be data that is not relevant or is less relevant to the particular task. A filter(s) can be selected and/or deselected through the input device 112 and/or otherwise. Examples of suitable filters include, but are not limited to, time window; frequency count; rareness criteria (e.g., season, humidity, time of day, etc.), symbolic tag subset restriction, prior event points annotated earlier for debugging purpose showing importance for cause-effect analysis, etc.

FIG. 5 illustrates a variation of FIG. 2 that includes the search engine 302 of FIG. 3, the one or more additional filters 402 of FIG. 4, and template updater 502 and/or the one or more additional filters 402. The template updater evaluates activity and/or results of the search engine 302 and/or the one or more additional filters 402. The evaluation, in one instance, trends the results and determines a frequency in which retrieved log data is removed from display and/or previously unretrieved log data is retrieved and displayed. Machine learning and/or other approaches can learn from the evaluation and update the template file 204 to include additional data tags and/or remove data tags.

In a variation of FIG. 5, the search engine 302 is omitted. In another variation of FIG. 5, the one or more additional filters 402 are omitted.

FIG. 6 illustrates a variation of FIG. 2 that includes a concept map generator 602 that generates one or more concepts maps which include graphical indicia that is link or map to the reference data 208 and hence the log files and data, and visually organizes the data, for example, based on time, topic, modality, importance, events, trends, concept, search, etc.

FIGS. 7-10 illustrates the concept map for selecting different metadata information extracted from the device log files along with search interface with filters to dynamically visualize concept maps.

A non-limiting example of a time concept map is shown in FIG. 7. In this example, a time bar 702 provides a plurality of time ranges, for example, time ranges 704₁, . . ., 704_{N}, where _{N} is a positive integer, in which data can be retrieved. The data can correspond to a modality 706, a geographical and/or vendor location 708, a particular model 710 of a modality, cost and/or parts 712, etc. A dialogue box 714 indicates a current selection of choices. A results window 716 includes links to data.

A non-limiting example of a topic concept map is shown in FIG. 8. In this example, data is available for one or more topics 802, without any time restriction.

A non-limiting example of a modality concept map is shown in FIG. 9. The concept in FIG. 9 also includes individual tabs for switching between modality, time, topic, etc. concept maps.

In FIGS. 7-9, the concept maps included graphical indicia.

In FIGS. 10 and 11, textual indicia is utilized.

Generally, the information in a concept map can be visualized in a 2D, 3D and/or other form. Furthermore, the information in a concept map may be expandable, zoomable, collapsible, and/or otherwise manipulable via the input device 112 (e.g., “clicking” on, hovering over, etc.) and/or other actions. Within a concept map, annotations (e.g., key concepts) to and links between data can be manually and/or automatically added.

The log data can be compared and/or analyzed to identify or provide information that can be used to identify warnings, mistakes, erroneous actions, machine deterioration, etc. to identify errors and corrective actions. Furthermore, log data can be used to find or provide information that can be used to find connections between the logs and key performance indicators (KPIs), and/or infer or provide information that can be used to infer multiple and alternate pathways for optimizing KPI's.

The log data can also be used to infer or provide information that can be used to infer future behavior based on the past and the present, and/or predict or provide information that can be used to predict future course of action from the past history. The log data can also be used to estimate or provide information that can be used to estimate and/or volume/velocity/variety and/or project or provide information that can be used to project future needs along multiple dimensions.

The log data can also be used to predict or provide information that can be used to predict future rare events such as disastrous machine failure from the past records, and/or provide high alerts in such situations. The foregoing can be achieved in a periodic, a dynamic, and/or automated or semi-automated manner with user confirmation and/or over-ride.

FIG. 12 illustrate methods in accordance with the embodiments herein.

It is to be appreciated that the ordering of the acts is not limiting. As such, other orderings are contemplated herein. In addition, one or more acts may be omitted and/or one or more additional acts may be included.

At 1202, flat files, including at least device log files and optionally service and/or other log files, are accessed. As described herein, the flat files can be received in a data stream, retrieved from memory, and/or otherwise accessed.

At 1204, the flat files are filtered based on a template to locate a predetermined set of data in the flat files. The template, as discussed herein, may include tags to relevant data and, optionally, debug levels and/or other information.

At 1206, references, which provide references to the located data in the flat files, are generated for the located data.

At 1208, the references are stored based on a predetermined organization.

At 1210, a first signal, which includes at least one or more data types of interest, is received. The first signal may also include debug level and/or other information.

At 1212, the references are utilized to retrieve data from the flat files based on the first signal.

At 1214, the retrieved data is visually presented in concept map and/or otherwise.

At 1216, a second signal, which indicates a filter that removes unwanted data, is received.

At 1218, the displayed data is updated based on the filter results.

At 1220, a third signal, which provides at least one search term for data not already displayed, is received.

At 1222, the flat files and/or references are searched based on the third signal.

At 1224, the displayed data is updated based on the search results.

In a variation, acts 1216 and 1218 and/or acts 1220, 1222 and 1224 are omitted.

The above methods may be implemented by way of computer readable instructions, encoded or embedded on computer readable storage medium, which, when executed by a computer processor(s), cause the processor(s) to carry out the described acts. Additionally or alternatively, at least one of the computer readable instructions is carried by a signal, carrier wave or other transitory medium.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A method, comprising:
searching a single file, which includes a plurality of device log files for one or more devices, based on a template file that at least indicates a sub-set of log data of interest;
generating reference data for each of the log data of interest that is located in the single file; and
storing the reference data in a data structure.

2. The method of claim 2, further comprising:
receiving a first signal that indicates data of interest in the single file;
identifying the reference data corresponding to the data of interest based on the first signal;
retrieving the identified data of interest from the single file; and
displaying only the retrieved data.

3. The method of claim 1, wherein the single file is a flat file that includes the plurality of device log files as a serial string of a data with no structural relationship between the data therein.

4. The method of claim 1, wherein the template file includes one or more of an XML file or a B-tree.

5. The method of claim 1, wherein the template file further includes debug levels for the sub-set of data of interest, and further comprising:
storing the reference data along with the corresponding debug levels.

6. The method of claim 5, further comprising:
receiving a first signal that indicates data of interest in the single file and a debug level of interest;
identifying the reference data corresponding to the data of interest and the debug level of interest based on the first signal;
retrieving the identified data of interest from the single file; and
displaying only the retrieved data.

7. The method of claim 6, further comprising:
receiving an input indicating a different debug level of interest;
identifying the reference data corresponding to the data of interest based on the first signal and the different debug level;
increasing or decreasing the identified data of interest from the single file based on the debug level;
retrieving the identified data of interest from the single file; and
displaying only the retrieved data.

8. The method of claim 7, further comprising:
updating the template file to include the different debug level of interest.

9. The method of claim 1, further comprising:
receiving a filter signal indicating a filter of interest;
filtering the retrieved data based on the filter signal; and
displaying only the filtered retrieved data.

10. The method of claim 9, wherein the filter filters the retrieved data based on one or more of time, frequency count, rareness criteria, a restriction, relevance, or an annotation.

11. The method of claim 1, further comprising:
receiving one or more search terms that are not included in the template file;
searching the data file for data corresponding to the one or more search terms;
retrieving data corresponding to the one or more search terms; and
displaying the search results.

12. The method of claim 10, further comprising:
updating the template file to include at least one of the one or more search terms.

13. The method of claim 1, further comprising:
visually presenting the displayed data in a concept map, which includes user selectable graphical indicia link to the reference data.

14. The method of claim 13, wherein the concept map visually organizes and presents the retrieved data based on one or more of time, topic, modality, importance, event, trend, or search.

15. A computing system, comprising:
a memory that stores one or more instructions including a log file processing module; and
a processor that executes the one or more instructions, which causes the processor to:
filter log data based on a template file that indicates streams of data of interest;
store the streams of data of interest; and
display, in response to an input signal, a sub-set of the stored virtual stream of data of interest.

16. The computing system of claim 15, wherein the executing of the one or more instructions further causes the processor to:
further filter the log data based a debug level of interest.

17. The computing system of claim 15, wherein the executing of the one or more instructions further causes the processor to:
filter the displayed at least one stored virtual stream of data of interest based on one or more of time, frequency count, rareness criteria, a restriction, relevance, or an annotation; and
display the filtered sub-set of the stored virtual stream of data of interest.

18. The computing system of claim 15, wherein the executing of the one or more instructions further causes the processor to:
search the log data based on search terms of interest; and
display virtual stream of data of interest from results of the search.

19. The computing system of claim 15, wherein the executing of the one or more instructions further causes the processor to: organize and the display data in a concept map.

20. A computer readable storage medium encoded with one or more computer executable instructions, which, when executed by a processor of a computing system, causes the processor to:
retrieve, using references, a sub-set of log data from a flat file of log data, in response to a user input, which includes at least an indication of data of interest to the user; and
display only the retrieved sub-set of log data in a predetermined organized manner in a user-interactive navigational graphical user interface.
